(19) United States
(12) Patent Application Publication
(10) Pub. No.: US 2024/0323186 A1
(43) Pub. Date: Sep. 26, 2024

(54) INTEGRATED SYSTEM, INTERFACE CALLING METHOD, AUTHENTICATION METHOD, AND RELATED DEVICE

(71) Applicant: Beijing Zitiao Network Technology Co., Ltd., Beijing (CN)

(72) Inventor: Denglin WANG, Beijing (CN)

(21) Appl. No.: 18/614,378

(22) Filed: Mar. 22, 2024

(30) Foreign Application Priority Data
Mar. 22, 2023 (CN) 202310288253.2

(51) Int. Cl. H04L 9/40

(52) U.S. Cl. CPC H04L 63/0876

(57) ABSTRACT

The present application discloses an integrated system, an interface calling method, an authentication method and a related device. The integrated system includes a plurality of connection modules and a target authentication module. The plurality of connection modules are connected to a target business system included in a business system set, and the target authentication module is connected to each target business system. The target connection module is configured to send an authentication request including a connection module identifier to the target authentication module in response to acquiring a call instruction of a target interface. The target authentication module is configured to send an authentication result to the target connection module identified by the connection module identifier in response to acquiring the authentication request. The target connection module is configured to acquire the authentication result from the target authentication module, and the authentication result is configured to call the target interface.

### CROSS-REFERENCE TO RELATED APPLICATION

The present application claims priority of Chinese Patent Application No. 202310288253.2, filed on Mar. 22, 2023, and the entire content disclosed by the Chinese patent application is incorporated herein by reference as part of the present application for all purposes under the U.S. law.

### TECHNICAL FIELD

The present application relates to the technical field of computers, and in particular to an integrated system, an interface calling method, an authentication method and a related device.

### BACKGROUND

An integrated system is used to integrate business services provided by different business systems. The integrated system establishes connection with the business system by an interface of the business system, and provides a user with the business service supported by the connected business system. When the user triggers to use the business service, the integrated system calls the interface connected to the business system that provides the business service, and the business system is used to provide the business service to the user.

In order to ensure security, the business system needs to authenticate permission of the integrated system before the interface is called. Developers need to configure corresponding authentication information for the interface connected to the business system in the integrated system, so that the integrated system can use the authentication information to complete permission authentication before calling the interface. However, the integrated system supports a large number of interfaces for calling, which results in the developers needing to configure a lot of authentication information, and a cumbersome configuration process.

### SUMMARY

In view of this, the present application provides an integrated system, an interface calling method, an authentication method, and a related device, which can reduce the number of times that developers configure authentication information and simplify the configuration process.

Based on this, the technical solution provided by the application is as follows:

According to a first aspect of the present application, an integrated system is provided. The integrated system includes a plurality of connection modules and a target authentication module, the plurality of connection modules are connected to a target business system included in a business system set, the target authentication module is connected to each target business system included in the business system set, and authentication information required for the target business system included in the business system set is the same;
the target connection module is configured to send an authentication request to the target authentication module in response to acquiring a call instruction of a target interface, the target interface is an interface of one target business system included in the business system set, the target connection module is a connection module connected to the target business system to which the target interface belongs in the plurality of connection modules, the authentication request comprises a connection module identifier, and the connection module identifier is configured to identify the target connection module;
the target authentication module is configured to send an authentication result to the target connection module identified by the connection module identifier in response to acquiring the authentication request, and the authentication result is obtained by the target authentication module using the authentication information to authenticate in the target business system; and
the target connection module is further configured to acquire the authentication result fed back from the target authentication module, and the authentication result is configured to call the target interface.

According to a second aspect of the present application, an interface calling method is provided. The method is applied to a target connection module included in an integrated system. The target connection module is connected to a target business system, the target business system belongs to a business system set, and authentication information required for the target business system included in the business system set is the same. The method comprises:
in response to acquiring a call instruction of a target interface, sending an authentication request to a target authentication module included in the integrated system, wherein the target interface is an interface of the target business system, the authentication request comprises a connection module identifier, the connection module identifier is configured to identify the target connection module, and the target authentication module is connected to the target business system, and the target authentication module is configured to obtain an authentication result based on using the authentication information to authenticate in the target business system; and
acquiring the authentication result fed back from the target authentication module, wherein the authentication result is configured to call the target interface.

According to a third aspect of the present application, an authentication method is provided. The authentication method is applied to a target authentication module included in an integrated system. The target authentication module is connected to each target business system included in a business system set, authentication information required for the target business system included in the business system set is the same. The method comprises:
in response to acquiring an authentication request, sending an authentication result to the target connection module identified by a connection module identifier included in the authentication request. The authentication result is obtained by the target authentication module using the authentication information to authenticate in the target business system, the authentication result is configured to call a target interface, and the target connection module is connected to the target business system included in the business system set, and the target connection module is configured to call the target interface of the target business system.

According to a fourth aspect of the present application, an interface calling apparatus is provided. The interface calling apparatus is applied to a target connection module included in an integrated system. The target connection module is connected to a target business system, the target business system belongs to a business system set, and authentication information required for the target business system included in the business system set is the same. The apparatus comprises:
a receiving unit, configured to acquire a call instruction for a target interface; and
a sending unit, configured to send an authentication request to a target authentication module included in the integrated system in response to acquiring the call instruction of the target interface, wherein the target interface is an interface of the target business system, the authentication request comprises a connection module identifier, the connection module identifier is configured to identify the target connection module, and the target authentication module is connected to the target business system, and the target authentication module is configured to obtain an authentication result based on using the authentication information to authenticate in the target business system, and
the receiving unit is further configured to acquire the authentication result fed back from the target authentication module, and the authentication result is configured to call the target interface.

According to a fifth aspect of the present application, an authentication apparatus is provided. The authentication apparatus is applied to a target authentication module included in an integrated system. The target authentication module is connected to each target business system included in a business system set, and authentication information required for the target business system included in the business system set is the same. The apparatus comprises:
a receiving unit, configured to acquire an authentication request; and
a sending unit, configured to send an authentication result to the target connection module identified by a connection module identifier included in the authentication request in response to acquiring the authentication request. The authentication result is obtained by the target authentication module using the authentication information to authenticate in the target business system, the authentication result is configured to call a target interface, and the target connection module is connected to the target business system included in the business system set, and the target connection module is configured to call the target interface of the target business system.

According to a sixth aspect of the present application, an electronic device is provided. The electronic device includes:
one or more processors; and
a storage apparatus storing one or more programs,
when the one or more programs are executed by the one or more processors, the one or more processors implement the interface calling method according to the third aspect, or implement the authentication method according to the fourth aspect.

According to a seventh aspect of the present application, a computer-readable medium is provided. A computer program is stored on the computer-readable medium, and when the program is executed by a processor, the interface calling method according to the third aspect, or the authentication method according to the fourth aspect is implemented.

According to a eighth aspect of the present application, a computer program product is provided. When the computer program product runs on a device, the device performs the interface calling method according to the third aspect, or performs the authentication method according to the fourth aspect.

Thus, the present application has the following beneficial effects:

The present application provide an integrated system, an interface calling method, an authentication method, and a related device. The integrated system includes a plurality of connection modules and a target authentication module. The plurality of the connection modules are connected to a target business system included in a business system set, the target authentication module is connected to each target business system included in the business system set, and authentication information required for the target business system included in the business system set is the same. The target connection module is configured to send an authentication request including a connection module identifier to the target authentication module in response to acquiring a call instruction of a target interface; the target authentication module is configured to send an authentication result to the target connection module identified by the connection module identifier in response to acquiring the authentication request; and the target connection module is further configured to acquire the authentication result fed back from the target authentication module, and the authentication result is configured to call the target interface. In this way, the plurality of connection modules that call the interface of the target business system can be authenticated uniformly by the target authentication module. The developers only need to configure the authentication information of the target authentication module, and do not need to configure it for each connection module, thus reducing the number of times for the developers to configure the authentication information, simplifying the configuration process and improving the configuration efficiency.

### BRIEF DESCRIPTION OF THE DRAWINGS

FIG. 1 is a schematic diagram of an integrated system;

FIG. 2 is a schematic diagram of an integrated system provided by an embodiment of the present application;

FIG. 3 is a schematic diagram of another integrated system provided by an embodiment of the present application;

FIG. 4 is a flowchart of interaction between a connection module and a target authentication module provided by an embodiment of the present application;

FIG. 5 is a schematic diagram of an interface calling apparatus provided by an embodiment of the present application;

FIG. 6 is a schematic diagram of an authentication apparatus provided by an embodiment of the present application; and

FIG. 7 is a schematic diagram of a basic structure of an electronic device provided by an embodiment of the present application.

### DETAILED DESCRIPTION

In order to facilitate the understanding and explanation of the technical schemes provided by embodiments of the present application, the background art of the present application is firstly described below.

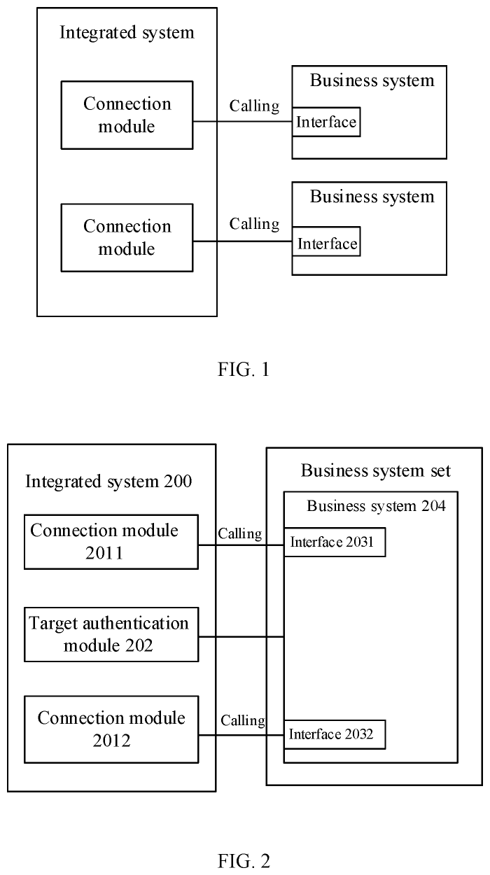

As shown in FIG. 1, this figure is a schematic diagram of an integrated system. The integrated system includes a plurality of connection modules. Each connection module is configured to call an interface of a business system and provide a user with a service provided by the business system.

In related technologies, developers need to configure authentication information for each connection module. After the integrated system receives the user's request for the use of the business service, it triggers the connection module that can call the interface to realize the business service. The connection module uses the pre-configured authentication information to send an authentication request including the authentication information to the business system. After processing the authentication request, the business system confirms that the connection module has authority to call the interface and feeds back an authentication result with authentication-pass to the connection module. After the connection module uses the authentication information to authenticate successfully, it calls the interface of the business system and provides the service for the user. In some cases, some business systems require the same authentication information. The developers need to configure the same authentication information many times, and the configuration process is relatively cumbersome.

Based on this, the embodiments of the present application provide an integrated system, an interface calling method, an authentication method, and a related device. The integrated system includes a plurality of connection modules and a target authentication module. The plurality of the connection modules are connected to a target business system included in a business system set, the target authentication module is connected to each target business system included in the business system set, and authentication information required for the target business system included in the business system set is the same. The target connection module is configured to send an authentication request including a connection module identifier to the target authentication module in response to acquiring a call instruction of a target interface; the target authentication module is configured to send an authentication result to the target connection module identified by the connection module identifier in response to acquiring the authentication request; and the target connection module is further configured to acquire the authentication result fed back from the target authentication module, and the authentication result is configured to call the target interface. In this way, the plurality of connection modules that call the interface of the target business system can be authenticated uniformly by the target authentication module. The developers only need to configure the authentication information of the target authentication module, and do not need to configure it for each connection module, thus reducing the number of times for the developers to configure the authentication information, simplifying the configuration process and improving the configuration efficiency.

In order to facilitate the understanding of the technical schemes provided by the embodiments of the present application, the integrated system provided by the embodiments of the present application is described below with the attached drawings.

As shown in FIG. 2, this figure is a schematic structure diagram of an integrated system provided by an embodiment of the present application. The integrated system 200 includes a connection module 2011 connected to an interface 2031 and a connection module 2012 connected to an interface 2032. The interface 2031 and the interface 2032 belong to a same business system 204. The business system 204 belongs to a business system set. Authentication information required for calling the interface 2031 and the interface 2032 is the same. The integrated system 200 also includes a target authentication module 202. The target authentication module 202 is connected to the business system 204. The developers pre-configure the authentication information of the target authentication module 202. The target authentication module 202 may send an authentication request to the business system 204 based on the authentication information, to obtain an authentication result. Before the connection module 2011 calls the interface 2031, and before the connection module 2012 calls the interface 2032, the authentication result is acquired from the target authentication module 202. The connection module 2011 calls the interface 2031 based on the authentication result indicating authentication passing. The connection module 2012 calls the interface 2032 based on the authentication result indicating authentication passing.

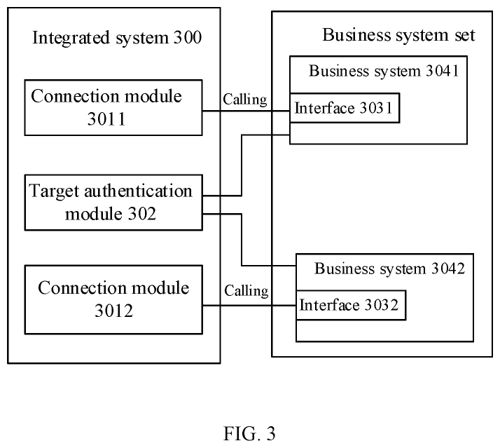

As shown in FIG. 3, this figure is a schematic structure diagram of another integrated system provided by an embodiment of the present application. The integrated system 300 includes a connection module 3011 connected to an interface 3031 and a connection module 3012 connected to an interface 3032. The interface 3031 belongs to a business system 3041. The interface 3032 belongs to a business system 3042. The business system 3041 and the business system 3042 belong to a same business system set. The business system 3041 and the business system 3042 require the same authentication information. In some possible implementation scenarios, the business system 3041 and the business system 3042 are business systems developed by the same enterprise. In other possible implementation scenarios, the business system 3041 and the business system 3042 are developed by different enterprises. Authentication information required for calling the interface 3031 and the interface 3032 is the same. The integrated system 300 also includes a target authentication module 302. The target authentication module 302 is connected to the business system 3041 and the business system 3042 respectively. The developers pre-configure the authentication information of the target authentication module 302. The target authentication module 302 may send an authentication request to the business system 3041 and the business system 3042 based on the authentication information, to obtain an authentication result. Before the connection module 3011 calls the interface 3031, and before the connection module 3012 calls the interface 3032, the authentication result is acquired from the target authentication module 302. The connection module 3011 calls the interface 3031 based on the authentication result indicating authentication passing. The connection module 3012 calls the interface 3032 based on the authentication result indicating authentication passing.

In this way, the developers do not need to configure the authentication information for different connection modules for many times. It only needs to configure the authentication information for the target authentication module to achieve authentication. Configuring the authentication information for the target authentication module can reduce the number of times for the developers to configure the authentication information, simplify the process for the developers to configure the authentication information, and facilitate the developer to configure the authentication information.

It can be understood by those skilled in the art that the framework schematic diagrams shown in FIGS. 2 and 3 are only an example in which the embodiments of the present application can be implemented. The application scope of the embodiment of the present application is not limited by any aspect of this framework. For example, the integrated system may be a business integration platform developed by a third party. The business system may be a server or a business platform of an application program that provides business services.

The integrated system provided by the embodiment of the present application is introduced below.

The integrated system is connected to the target business system included in the business system set. The business system set includes at least one target business system. Authentication information required for each target business system included in the business system set is the same. The target business system provides an interface to external parties in order to call the business system to provide the services through the interface. The embodiment of the present application does not limit a division mode of the business system set. In a possible implementation mode, the target business systems developed by the same enterprise and requiring the same authentication information are divided into the same business system set. In another possible implementation mode, the target business systems that require the same authentication information for authentication are divided into the same business system set only according to the authentication information.

The integrated system includes a plurality of connection modules and a target authentication module. The plurality of connection modules are connected to the target business system included in the business system set. The connection module is configured to call the interface provided by the target business system. It should be noted that one target business system may have a plurality of interfaces, and different interfaces are configured to provide different services. Different connection modules may be configured to call the different interfaces. The interfaces called by the connection modules may be pre-configured.

The embodiment of the present application does not limit a connection mode between the connection module and the target business system. In a possible implementation mode, the business system set includes one target business system, and the plurality of the connection modules are connected to the target business system respectively. In another possible implementation mode, the business system set includes a plurality of target business systems. The plurality of connection modules may be connected to a same target business system. Alternatively, the plurality of connection modules includes a connection module connected to different target business systems.

The target authentication module is connected to each target business system included in the business system set. The developers pre-configure authentication information required for the authentication of the target authentication module. The authentication information is information required for the target business system to authenticate the authority called by the interface. As an example, the authentication information is identity information. The identity information is, for example, an identity identifier, an account identifier, or an account password. As another example, the authentication information is pre-agreed information, such as an encryption result obtained by encrypting agreed data with a pre-agreed encryption algorithm.

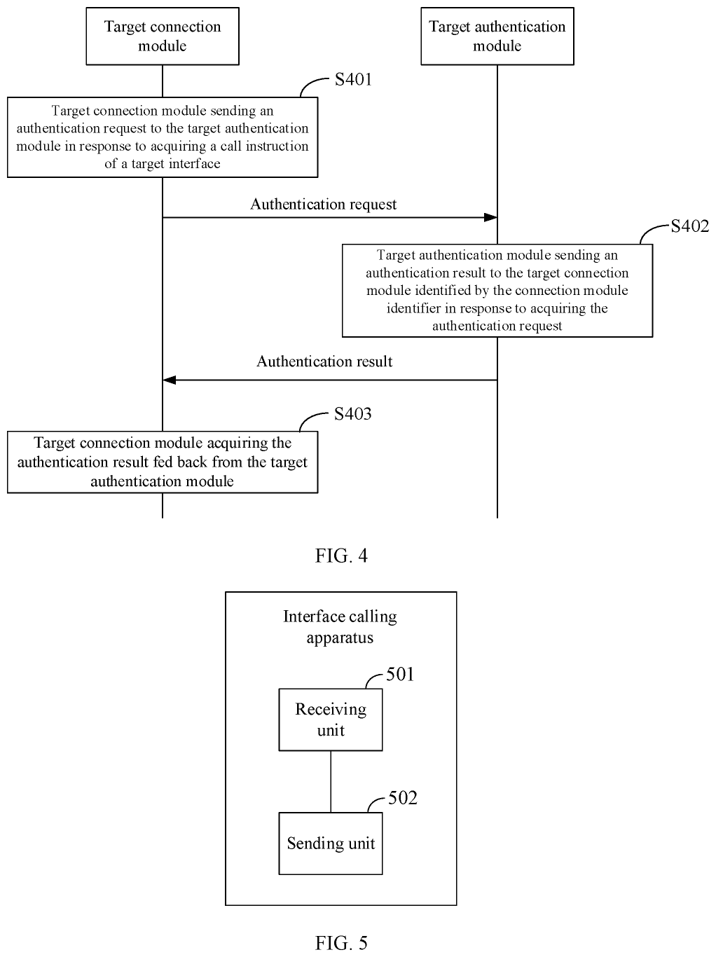

As shown in FIG. 4, this figure is a flowchart of interaction between a connection module and a target authentication module provided by an embodiment of the present application.

S401: the target connection module sending an authentication request to the target authentication module in response to acquiring a call instruction of a target interface.

The target connection module is a user-triggered connection module that needs to call the target interface. It can be understood that the integrated system includes a plurality of business services that can be realized. The user can trigger the use of the business services. The integrated system triggers the target connection module connected to the target interface of the target business system providing the business service to call the target interface. In a possible implementation mode, the integrated system sends a call instruction to the target connection module in response to the business service triggered by the user. In another possible implementation mode, the user selects the triggered target connection module, triggers the generation of the call instruction, and sends the call instruction to the target connection module. The call instruction is configured to trigger the target connection module to call the target interface of the target business system. The target interface of the target business system called by the target connection module is pre-configured. The target interface is one of the interfaces provided by the target business system.

The target connection module sends the authentication request to the target authentication module in response to acquiring the call instruction. The authentication request includes a connection module identifier. The connection module identifier is configured to identify the target connection module, so that the target authentication module can feed an authentication result back to the target connection module based on the connection module identifier. The connection module identifier is, for example, a name of the target connection module or a number of the target connection module.

The target authentication module is a module configured to authenticate with the target business system. The embodiment of the present application does not limit specific implementation modes of the target connection module to determine the target authentication module. The embodiment of the present application provides two implementation modes for determining the target authentication module by the target connection module.

First, the target authentication module has a corresponding relationship with the target business system. Before sending an authentication request to the target authentication module, the target connection module determines the target authentication module firstly based on the corresponding relationship between the target business system to which the target interface to be called by the call instruction belongs and the target authentication module. The corresponding relationship between the target authentication module and the target business system is pre-stored in the integrated system. The target connection module can query the target authentication module corresponding to the target business system.

Second, the target connection module pre-configures a model identifier of the target authentication module. The model identifier of the target authentication module is configured to identify the target authentication module. The model identifier of the target authentication module is pre-configured in the target connection module, and the target connection module sends the authentication request to the target authentication module identified by the model identifier.

S402: the target authentication module sending an authentication result to the target connection module identified by the connection module identifier in response to acquiring the authentication request.

The authentication result is obtained by the target authentication module using the authentication information to authenticate in the target business system. The authentication information is pre-configured information for authentication in the target business system. The authentication information may be configured based on the authentication requirement of the target business system and the information possessed by the integrated system. The authentication information includes, for example, an identifier, a user identifier, a password, or a key. It should be noted that in some possible implementation modes, different target business systems require different authentication information. The information content of the same type of authentication information may also be different. For example, the authentication information required for the different business systems all includes the user identifier and the password. However, the user has different user identifiers and passwords configured in the different business systems.

The embodiment of the present application does not limit implementation modes for acquiring the authentication result by the target authentication module. In a possible implementation mode, the target authentication module starts authentication based on acquiring the authentication request. The target authentication module sends the authentication information to the target business system in response to acquiring the authentication request. The target business system can authenticate based on the authentication information to determine whether the integrated system has the authority to call the interface. The target business system feeds the authentication result back to the target authentication module. In another possible implementation mode, the time for triggering the target authentication module to authenticate is not limited. The target authentication module may authenticate after acquiring the authentication request, or authenticate at other times. The target authentication module sends the authentication information to the target business system. The target business system can authenticate based on the authentication information. After the authentication of the target business system is passed, the target business system sends the authentication result to the target authentication module. The authentication result is authorization information. The authorization information is, for example, a password. In this way, the target authentication module feeds the obtained authorization information back to the target connection module after acquiring the authentication request. In addition, the authorization information has timeliness, and the authorization information has an effective time limit. After the effective time limit is reached, the authorization information is invalid. In this way, the security of accessing the target business system can be improved. The target authentication module is also configured to send the authentication information to the target business system and acquire authorization information with updated effective time limit fed back from the target business system in response to determining that the effective time limit is less than a threshold. In this way, the authorization information acquired by the target authentication module can be guaranteed to remain valid, and it is convenient for the target connection module to call the interface by using the valid authorization information without waiting for authentication.

By using the target authentication module, it is possible to authenticate with the target business system. The developers only need to configure the authentication information for the target authentication module. Moreover, the plurality of the connection modules can be authenticated by a target authentication module. The developers do not need to repeatedly configure authentication modules for the plurality of connection modules. In this way, the number of times for the developers to configure the authentication information is reduced, the configuration process is simplified, and the configuration efficiency is improved.

S403: the target connection module acquiring the authentication result fed back from the target authentication module.

The target connection module acquires the authentication result. The authentication result is configured to call the target interface. In a possible implementation mode, the authentication result indicates that the authentication is passed. The target connection module calls the target interface based on the authentication result. After calling the target interface, the target business system can be used to provide business services. In another possible implementation mode, the authentication result indicates that the authentication is not passed. The target connection module is failed to call the target interface.

Based on an integrated system provided by the above method embodiment, the embodiment of the present application further provide an interface calling method applied to a target connection module included in the integrated system, and the method includes:
in response to acquiring a call instruction of a target interface, sending an authentication request to a target authentication module included in the integrated system, wherein the target interface is an interface of the target business system, the authentication request includes a connection module identifier, the connection module identifier is configured to identify the target connection module, and the target authentication module is connected to the target business system and the target authentication module is configured to obtain an authentication result based on using the authentication information to authenticate in the target business system; and
acquiring the authentication result fed back from the target authentication module, wherein the authentication result is configured to call the target interface.

In a possible implementation mode, the target authentication module has a corresponding relationship with the target business system, and before sending the authentication request to the target authentication module, the method further includes:
determining the target authentication module according to the corresponding relationship between the target authentication module and the target business system.

In a possible implementation mode, the target connection module is pre-configured with a model identifier of the target authentication module, the model identifier is configured to identify the target authentication module, and the step of sending the authentication request to the target authentication module includes:
sending the authentication request to the target authentication module identified by the model identifier.

In a possible implementation mode, the authentication result is authentication passing, and the method further includes:
calling the target interface based on the authentication result.

For the specific description of the interface calling method applied to the target connection module included in the integrated system, please refer to the relevant description in the embodiment shown in FIG. 4, and it is not repeatedly described here.

Based on an integrated system provided by the above method embodiment, the embodiment of the present application further provide an authentication method applied to a target authentication module included in the integrated system, and the method includes:
in response to acquiring an authentication request, sending an authentication result to the target connection module identified by a connection module identifier included in the authentication request. The authentication result is obtained by the target authentication module using the authentication information to authenticate in the target business system, the authentication result is configured to call a target interface, and the target connection module is connected to the target business system included in the business system set, and the target connection module is configured to call the target interface of the target business system.

In a possible implementation mode, after responding to acquiring the authentication request and before sending the authentication result to the target connection module identified by the connection module identifier, the method further includes:
sending the authentication information to the target business system; and
acquiring the authentication result fed back from the target business system.

In a possible implementation mode, the authentication result is authorization information, and before sending the authentication result to the target connection module identified by the connection module identifier, the method further includes:
sending the authentication information to the target business system and acquiring the authorization information fed back from the target business system.

In a possible implementation mode, the authorization information has an effective time limit, and the method further includes:
in response to determining that the effective time limit is less than a threshold, sending the authentication information to the target business system and acquiring authorization information with updated effective time limit fed back from the target business system.

Based on an interface calling method provided by the above method embodiment, the embodiment of the present application further provide an interface calling apparatus. The interface calling apparatus is applied to a target connection module included in an integrated system. The interface calling apparatus is described below in combination with the attached drawings.

As shown in FIG. 5, this figure is a schematic structure diagram of an interface calling apparatus provided by an embodiment of the present application. As shown in FIG. 5, the interface calling apparatus includes:
a receiving unit 501, configured to acquire a call instruction for a target interface; and
a sending unit 502, configured to send an authentication request to a target authentication module included in the integrated system in response to acquiring the call instruction of the target interface. The target interface is an interface of the target business system, the authentication request includes a connection module identifier, the connection module identifier is configured to identify the target connection module, and the target authentication module is connected to the target business system, and the target authentication module is configured to obtain an authentication result based on using the authentication information to authenticate in the target business system, and
the receiving unit 501 is also configured to acquire the authentication result fed back from the target authentication module, and the authentication result is configured to call the target interface.

In some possible implementation modes, the target authentication module has a corresponding relationship with the target business system, and the apparatus further includes:
a determining unit, configured to determine the target authentication module according to the corresponding relationship between the target authentication module and the target business system.

In some possible implementation modes, the target connection module is pre-configured with a model identifier of the target authentication module, the model identifier is configured to identify the target authentication module, and the sending unit 502 being configured to send the authentication request to the target authentication module includes:
the sending unit 502 being configured to send the authentication request to the target authentication module identified by the model identifier.

In some possible implementation modes, the authentication result is authentication passing, and the apparatus further includes:
a calling unit, configured to call the target interface based on the authentication result.

Based on an authentication method provided by the above embodiment, the embodiment of the present application further provide an authentication apparatus, the authentication apparatus is applied to a target authentication module included in an integrated system, and the authentication apparatus is described below in combination with the attached drawings.

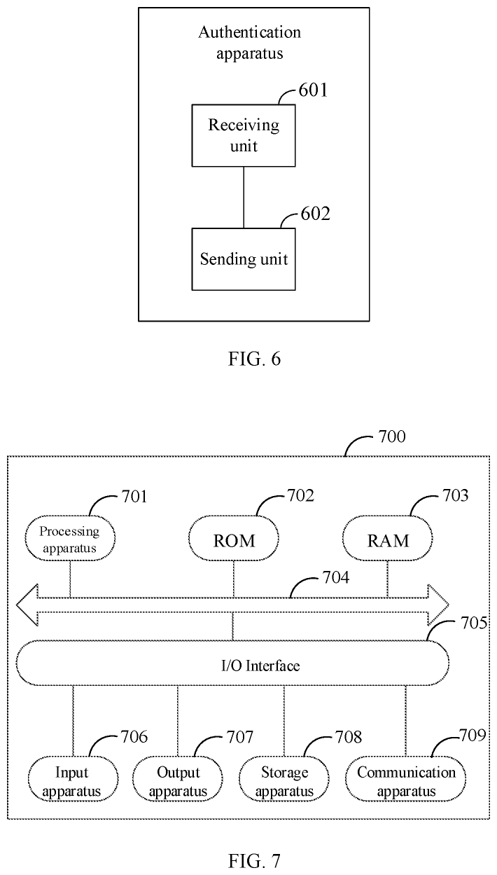

As shown in FIG. 6, this figure is a schematic structure diagram of an authentication apparatus provided by an embodiment of the present application. As shown in FIG. 6, the authentication apparatus includes:
a receiving unit 601, configured to acquire an authentication request; and
a sending unit 602, configured to send an authentication result to the target connection module identified by a connection module identifier included in the authentication request in response to acquiring the authentication request. The authentication result is obtained by the target authentication module using the authentication information to authenticate in the target business system, the authentication result is configured to call the target interface, and the target connection module is connected to the target business system included in the business system set, and the target connection module is configured to call the target interface of the target business system.

In some possible implementation modes, the sending unit 602 is also configured to send the authentication information to the target business system in response to acquiring the authentication request; and
the receiving unit 601 is also configured to acquire the authentication result fed back
from the target business system.

In some possible implementation modes, the authentication result is authorization information;
the sending unit 602 is also configured to send the authentication information to the target business system; and
the receiving unit 601 is also configured to acquire the authorization information fed back from the target business system.

In some possible implementation modes, the authorization information has an effective time limit, and the sending unit 602 is also configured to send the authentication information to the target business system in response to determining that the effective time limit is less than a threshold; and
the receiving unit 601 is also configured to acquire authorization information with updated effective time limit fed back from the target business system.

Based on an interface calling method and an authentication method provided by the above method embodiments, the present application further provides an electronic device, including: one or more processors; and a storage apparatus storing one or more programs. When the one or more programs are executed by the one or more processors, the one or more processors implement the interface calling method or the authentication method according to any one of the above embodiments.

Referring to FIG. 7, FIG. 7 illustrates a schematic structural diagram of an electronic device 700 suitable for implementing some embodiments of the present application. The electronic devices in some embodiments of the present application may include but are not limited to mobile terminals such as a mobile phone, a notebook computer, a digital broadcasting receiver, a personal digital assistant (PDA), a portable Android device (PAD), a portable media player (PMP), a vehicle-mounted terminal (e.g., a vehicle-mounted navigation terminal) or the like, and fixed terminals such as a digital TV, a desktop computer, or the like. The electronic device illustrated in FIG. 7 is merely an example, and should not pose any limitation to the functions and the range of use of the embodiments of the present application.

As illustrated in FIG. 7, the electronic device 700 may include a processing apparatus 701 (e.g., a central processing unit, a graphics processing unit, etc.), which can perform various suitable actions and processing according to a program stored in a read-only memory (ROM) 702 or a program loaded from a storage apparatus 708 into a random-access memory (RAM) 703. The RAM 703 further stores various programs and data required for operations of the electronic device 700. The processing apparatus 701, the ROM 702, and the RAM 703 are interconnected by means of a bus 704. An input/output (I/O) interface 705 is also connected to the bus 704.

Usually, the following apparatus may be connected to the I/O interface 705: an input apparatus 706 including, for example, a touch screen, a touch pad, a keyboard, a mouse, a camera, a microphone, an accelerometer, a gyroscope, or the like; an output apparatus 707 including, for example, a liquid crystal display (LCD), a loudspeaker, a vibrator, or the like; a storage apparatus 708 including, for example, a magnetic tape, a hard disk, or the like; and a communication apparatus 709. The communication apparatus 709 may allow the electronic device 700 to be in wireless or wired communication with other devices to exchange data. While FIG. 7 illustrates the electronic device 700 having various apparatuses, it should be understood that not all of the illustrated apparatuses are necessarily implemented or included. More or fewer apparatuses may be implemented or included alternatively.

Particularly, according to some embodiments of the present application, the processes described above with reference to the flowcharts may be implemented as a computer software program. For example, some embodiments of the present application include a computer program product, which includes a computer program carried by a non-transitory computer-readable medium. The computer program includes program codes for performing the methods shown in the flowcharts. In such embodiments, the computer program may be downloaded online through the communication apparatus 709 and installed, or may be installed from the storage apparatus 708, or may be installed from the ROM 702. When the computer program is executed by the processing apparatus 701, the above-mentioned functions defined in the methods of some embodiments of the present application are performed.

The electronic device provided by the embodiment of the present application and the interface calling method or authentication method provided by the above embodiments belong to the same inventive concept. Technical details which are not fully described in this embodiment may be found in the above embodiments, and this embodiment has the same beneficial effects as the above embodiments.

Based on an interface calling method or an authentication method provided by the above method embodiment, the embodiment of the present application provide a computer storage medium on which a computer program is stored. When the program is executed by a processor, the interface calling method or the authentication method according to any one of the above embodiments is implemented.

It should be noted that the above-mentioned computer-readable medium in the present application may be a computer-readable signal medium or a computer-readable storage medium or any combination thereof. For example, the computer-readable storage medium may be, but not limited to, an electric, magnetic, optical, electromagnetic, infrared, or semiconductor system, apparatus or device, or any combination thereof. More specific examples of the computer-readable storage medium may include but not be limited to: an electrical connection with one or more wires, a portable computer disk, a hard disk, a random-access memory (RAM), a read-only memory (ROM), an erasable programmable read-only memory (EPROM or flash memory), an optical fiber, a compact disk read-only memory (CD-ROM), an optical storage device, a magnetic storage device, or any appropriate combination of them. In the present application, the computer-readable storage medium may be any tangible medium containing or storing a program that can be used by or in combination with an instruction execution system, apparatus or device. In the present application, the computer-readable signal medium may include a data signal that propagates in a baseband or as a part of a carrier and carries computer-readable program codes. The data signal propagating in such a manner may take a plurality of forms, including but not limited to an electromagnetic signal, an optical signal, or any appropriate combination thereof. The computer-readable signal medium may also be any other computer-readable medium than the computer-readable storage medium. The computer-readable signal medium may send, propagate or transmit a program used by or in combination with an instruction execution system, apparatus or device. The program code contained on the computer-readable medium may be transmitted by using any suitable medium, including but not limited to an electric wire, a fiber-optic cable, radio frequency (RF) and the like, or any appropriate combination of them.

In some implementation modes, the client and the server may communicate with any network protocol currently known or to be researched and developed in the future such as hypertext transfer protocol (HTTP), and may communicate (via a communication network) and interconnect with digital data in any form or medium. Examples of communication networks include a local area network (LAN), a wide area network (WAN), the Internet, and an end-to-end network (e.g., an ad hoc end-to-end network), as well as any network currently known or to be researched and developed in the future.

The above-mentioned computer-readable medium may be included in the above-mentioned electronic device, or may also exist alone without being assembled into the electronic device.

The computer-readable medium carries one or more programs, and when the one or more programs are executed by the electronic device, the electronic device is caused to execute the interface calling method or the authentication method.

The computer program codes for performing the operations of the present application may be written in one or more programming languages or a combination thereof. The above-mentioned programming languages include but are not limited to object-oriented programming languages such as Java, Smalltalk, C++, and also include conventional procedural programming languages such as the “C” programming language or similar programming languages. The program code may be executed entirely on the user's computer, partly on the user's computer, as a stand-alone software package, partly on the user's computer and partly on a remote computer, or entirely on the remote computer or server. In the scenario related to the remote computer, the remote computer may be connected to the user's computer through any type of network, including a local area network (LAN) or a wide area network (WAN), or the connection may be made to an external computer (for example, through the Internet using an Internet service provider).

The flowcharts and block diagrams in the accompanying drawings illustrate the architecture, functionality, and operation of possible implementations of systems, methods, and computer program products according to various embodiments of the present application. In this regard, each block in the flowcharts or block diagrams may represent a module, a program segment, or a portion of codes, including one or more executable instructions for implementing specified logical functions. It should also be noted that, in some alternative implementations, the functions noted in the blocks may also occur out of the order noted in the accompanying drawings. For example, two blocks shown in succession may, in fact, can be executed substantially concurrently, or the two blocks may sometimes be executed in a reverse order, depending upon the functionality involved. It should also be noted that, each block of the block diagrams and/or flowcharts, and combinations of blocks in the block diagrams and/or flowcharts, may be implemented by a dedicated hardware-based system that performs the specified functions or operations, or may also be implemented by a combination of dedicated hardware and computer instructions.

The modules or units involved in the embodiments of the present application may be implemented in software or hardware. Among them, the name of the module or unit does not constitute a limitation of the unit itself under certain circumstances.

The functions described herein above may be performed, at least partially, by one or more hardware logic components. For example, without limitation, available exemplary types of hardware logic components include: a field programmable gate array (FPGA), an application specific integrated circuit (ASIC), an application specific standard product (ASSP), a system on chip (SOC), a complex programmable logical device (CPLD), etc.

In the context of the present application, the machine-readable medium may be a tangible medium that may include or store a program for use by or in combination with an instruction execution system, apparatus or device. The machine-readable medium may be a machine-readable signal medium or a machine-readable storage medium. The machine-readable medium includes, but is not limited to, an electrical, magnetic, optical, electromagnetic, infrared, or semi-conductive system, apparatus or device, or any suitable combination of the foregoing. More specific examples of machine-readable storage medium include electrical connection with one or more wires, portable computer disk, hard disk, random-access memory (RAM), read-only memory (ROM), erasable programmable read-only memory (EPROM or flash memory), optical fiber, portable compact disk read-only memory (CD-ROM), optical storage device, magnetic storage device, or any suitable combination of the foregoing.

According to one or more embodiments of the present application, Example 1 provides an integrated system. The integrated system includes a plurality of connection modules and a target authentication module, the plurality of connection modules are connected to a target business system included in a business system set, the target authentication module is connected to each target business system included in the business system set, and authentication information required for the target business system included in the business system set is the same. The target connection module is configured to send an authentication request to the target authentication module in response to acquiring a call instruction of a target interface, the target interface is an interface of one target business system included in the business system set, the target connection module is a connection module connected to the target business system to which the target interface belongs in the plurality of connection modules, the authentication request includes a connection module identifier, and the connection module identifier is configured to identify the target connection module. The target authentication module is configured to send an authentication result to the target connection module identified by the connection module identifier in response to acquiring the authentication request, and the authentication result is obtained by the target authentication module using the authentication information to authenticate in the target business system. The target connection module is further configured to acquire the authentication result fed back from the target authentication module, and the authentication result is configured to call the target interface.

According to one or more embodiments of the present application, Example 2 provides the integrated system, and the target authentication module is further configured to send the authentication information to the target business system and acquire the authentication result fed back from the target business system after responding to acquiring the authentication request and before sending the authentication result to the target connection module identified by the connection module identifier.

According to one or more embodiments of the present application, Example 3 provides the integrated system, and the authentication result is authorization information. The target authentication module is further configured to send the authentication information to the target business system and acquire authorization information fed back from the target business system before sending the authentication result to the target connection module identified by the connection module identifier.

According to one or more embodiments of the present application, Example 4 provides the integrated system, and the authorization information has an effective time limit. The target authentication module is further configured to send the authentication information to the target business system and acquire authorization information with updated effective time limit fed back from the target business system in response to determining that the effective time limit is less than a threshold.

According to one or more embodiments of the present application, Example 5 provides the integrated system, and the target authentication module has a corresponding relationship with the target business system. The target connection module is further configured to determine the target authentication module according to the corresponding relationship between the target authentication module and the target business system before sending the authentication request to the target authentication module.

According to one or more embodiments of the present application, Example 6 provides the integrated system, and the target connection module is pre-configured with a model identifier of the target authentication module, in which the model identifier is configured to identify the target authentication module. The target connection module being configured to send the authentication request to the target authentication module includes:
the target connection module being configured to send the authentication request to the target authentication module identified by the model identifier.

According to one or more embodiments of the present application, Example 7 provides the integrated system, and the authentication result includes authentication passing, and the target connection module is further configured to call the target interface based on the authentication result.

According to one or more embodiments of the present application, Example 8 provides an interface calling method, and the method is applied to a target connection module included in an integrated system. The target connection module is connected to a target business system, the target business system belongs to a business system set, authentication information required for the target business system included in the business system set is the same, and the method includes:
in response to acquiring a call instruction of a target interface, sending an authentication request to a target authentication module included in the integrated system, wherein the target interface is an interface of the target business system, the authentication request includes a connection module identifier, the connection module identifier is configured to identify the target connection module, and the target authentication module is connected to the target business system, and the target authentication module is configured to obtain an authentication result based on using the authentication information to authenticate in the target business system; and
acquiring the authentication result fed back from the target authentication module, wherein the authentication result is configured to call the target interface.

According to one or more embodiments of the present application, Example 9 provides the interface calling method, and the target authentication module has a corresponding relationship with the target business system. Before sending the authentication request to the target authentication module, the method further includes:
determining the target authentication module according to the corresponding relationship between the target authentication module and the target business system.

According to one or more embodiments of the present application, Example 10 provides the interface calling method, and the target connection module is pre-configured with a model identifier of the target authentication module. The model identifier is configured to identify the target authentication module, and sending the authentication request to the target authentication module includes:
sending the authentication request to the target authentication module identified by the model identifier.

According to one or more embodiments of the present application, Example 11 provides the interface calling method, and the authentication result includes authentication passing. The method further includes:
calling the target interface based on the authentication result.

According to one or more embodiments of the present application, Example 12 provides an authentication method, and the authentication method is applied to a target authentication module included in an integrated system. The target authentication module is connected to each target business system included in a business system set, authentication information required for the target business system included in the business system set is the same, and the method includes:
in response to acquiring an authentication request, sending an authentication result to the target connection module identified by a connection module identifier included in the authentication request. The authentication result is obtained by the target authentication module using the authentication information to authenticate in the target business system, the authentication result is configured to call a target interface, and the target connection module is connected to the target business system included in the business system set, and the target connection module is configured to call the target interface of the target business system.

According to one or more embodiments of the present application, Example 13 provides the authentication method, and after responding to acquiring the authentication request and before sending the authentication result to the target connection module identified by the connection module identifier, the method further includes:
sending the authentication information to the target business system; and
acquiring the authentication result fed back from the target business system.

According to one or more embodiments of the present application, Example 14 provides the authentication method, and the authentication result includes authorization information, and before sending the authentication result to the target connection module identified by the connection module identifier. The method further includes:
sending the authentication information to the target business system and acquiring the authorization information fed back from the target business system.

According to one or more embodiments of the present application, Example 15 provides the authentication method, and the authorization information has an effective time limit, and the method further includes:
in response to determining that the effective time limit is less than a threshold, sending the authentication information to the target business system and acquiring authorization information with updated effective time limit fed back from the target business system.

According to one or more embodiments of the present application, Example 16 provides an interface calling apparatus, and the interface calling apparatus is applied to a target connection module included in an integrated system. The target connection module is connected to a target business system, the target business system belongs to a business system set, authentication information required for the target business system included in the business system set is the same, and the apparatus includes:
a receiving unit, configured to acquire a call instruction for a target interface; and
a sending unit, configured to send an authentication request to a target authentication module included in the integrated system in response to acquiring the call instruction of the target interface, wherein the target interface is an interface of the target business system, the authentication request includes a connection module identifier, the connection module identifier is configured to identify the target connection module, and the target authentication module is connected to the target business system, and the target authentication module is configured to obtain an authentication result based on using the authentication information to authenticate in the target business system, and
the receiving unit is further configured to acquire the authentication result fed back from the target authentication module, and the authentication result is configured to call the target interface.

According to one or more embodiments of the present application, Example 17 provides the interface calling apparatus, and the target authentication module has a corresponding relationship with the target business system. The apparatus further includes:
a determining unit, configured to determine the target authentication module according to the corresponding relationship between the target authentication module and the target business system.

According to one or more embodiments of the present application, Example 18 provides the interface calling apparatus, and the target connection module is pre-configured with a model identifier of the target authentication module, the model identifier is configured to identify the target authentication module. The sending unit being configured to send the authentication request to the target authentication module includes:
the sending unit being configured to send the authentication request to the target authentication module identified by the model identifier.

According to one or more embodiments of the present application, Example 19 provides the interface calling apparatus, the authentication result is authentication passing, and the apparatus further includes:
a calling unit, configured to call the target interface based on the authentication result.

According to one or more embodiments of the present application, Example 20 provides an authentication apparatus, and the authentication apparatus is applied to a target authentication module included in an integrated system. The target authentication module is connected to each target business system included in a business system set, authentication information required for the target business system included in the business system set is the same, and the apparatus includes:
a receiving unit, configured to acquire an authentication request; and
a sending unit, configured to send an authentication result to the target connection module identified by a connection module identifier included in the authentication request in response to acquiring the authentication request, wherein the authentication result is obtained by the target authentication module using the authentication information to authenticate in the target business system, the authentication result is configured to call a target interface, and the target connection module is connected to the target business system included in the business system set, and the target connection module is configured to call the target interface of the target business system.

According to one or more embodiments of the present application, Example 21 provides the authentication apparatus, and the sending unit is also configured to send the authentication information to the target business system in response to acquiring the authentication request, and
the receiving unit is also configured to acquire the authentication result fed back from the target business system.

According to one or more embodiments of the present application, Example 22 provides the authentication apparatus, and the authentication result is authorization information,
the sending unit is also configured to send the authentication information to the target business system; and
the receiving unit is also configured to acquire the authorization information fed back from the target business system.

According to one or more embodiments of the present application, Example 23 provides the authentication apparatus, and the authorization information has an effective time limit. The sending unit is also configured to send the authentication information to the target business system in response to determining that the effective time limit is less than a threshold, and
the receiving unit is also configured to acquire authorization information with updated effective time limit fed back from the target business system.

According to one or more embodiments of the present application, Example 24 provides an electronic device, and the electronic device includes:
one or more processors; and
a storage apparatus storing one or more programs,
when the one or more programs are executed by the one or more processors, the one or more processors implement the interface calling method according to any one of Example 8-Example 11, or implement the authentication method according to any one of Example 12-Example 15.

According to one or more embodiments of the present application, Example 25 provides a computer-readable medium and a computer program is stored on the computer-readable medium. When the program is executed by a processor, the interface calling method according to any one of Example 8-Example 11, or the authentication method according to any one of Example 12-Example 15.

It should be noted that each embodiment in the description is described in a progressive manner, and each embodiment focuses on differences from other embodiments. The same and similar parts between each embodiment may be referred to each other. For systems or apparatuses disclosed in the embodiment, the description is relatively simple since it corresponds to methods disclosed in the embodiment. Please refer to the method section for relevant information.

It should be understood that in the present application, “at least one (item)” refers to one or more, and “plurality” refers to two or more. “And/or” is used to describe an association relationship of related objects, it is indicated that there may be three types of relationships. For example, “A and/or B” may represent: three situations that only A exists, only B exists, and A and B exist simultaneously, herein A and B may be singular or plural. The character “/” generally represents that front and back associated objects are an “or” relationship. “At least one (item) of the following” or its similar expression refers to any combinations of these items, including any combinations of single or complex items. For example, at least one (item) in a, b, or c may represent: a, b, c, “a and b”, “a and c”, “b and c”, or “a and b and c”, herein a, b, and c may be single or plurality.

It should also be noted that in this article, the relationship terms such as first and second are only used to distinguish one entity or operation from another entity or operation, and do not necessarily require or imply any actual relationships or orders between these entities or operations. Moreover, the terms “including”, “include”, “containing”, “contain”, or any other variations thereof are intended to encompass non-exclusive inclusion, so that a process, method, item, or device that includes a series of elements not only includes those elements, but also includes other elements that are not explicitly listed, or also includes elements inherent to such process, method, item, or device. In the case without further limitations, an element limited by the statement “including one . . . ” does not exclude the existence of other identical elements in the process, method, item, or device that includes the element.

The steps of the method or algorithm described in combination with the embodiments disclosed in this article may be directly implemented by using hardware, software modules executed by processors, or a combination of the two. The software modules may be placed in a random access memory (RAM), a memory, a read-only memory (ROM), an electrically programmable ROM, an electrically erasable programmable ROM, a register, a hard disk, a removable disk, a compact disk read-only memory (CD-ROM), or any other forms of storage media well-known in the technical field.

The above description of the embodiments disclosed enables those skilled in the art to implement or use the present application. Various modifications to these embodiments may be apparent to those skilled in the art, and the general principles defined in this article may be implemented in other embodiments without departing from the spirit or scope of the present application. Therefore, the present application may not be limited to the embodiments shown in this article, but rather to the widest scope consistent with the principles and novel features disclosed in this article.

1. An integrated system, comprising a plurality of connection modules and a target authentication module, wherein the plurality of connection modules are connected to a target business system included in a business system set, the target authentication module is connected to each target business system included in the business system set, and authentication information required for the target business system included in the business system set is the same;
the target connection module is configured to send an authentication request to the target authentication module in response to acquiring a call instruction of a target interface, the target interface is an interface of one target business system included in the business system set, the target connection module is a connection module connected to the target business system to which the target interface belongs in the plurality of connection modules, the authentication request comprises a connection module identifier, and the connection module identifier is configured to identify the target connection module;
the target authentication module is configured to send an authentication result to the target connection module identified by the connection module identifier in response to acquiring the authentication request, and the authentication result is obtained by the target authentication module using the authentication information to authenticate in the target business system; and
the target connection module is further configured to acquire the authentication result fed back from the target authentication module, and the authentication result is configured to call the target interface.

2. The system according to claim 1, wherein the target authentication module is further configured to send the authentication information to the target business system and acquire the authentication result fed back from the target business system after responding to acquiring the authentication request and before sending the authentication result to the target connection module identified by the connection module identifier.

3. The system according to claim 1, wherein the authentication result comprises authorization information, and the target authentication module is further configured to send the authentication information to the target business system and acquire authorization information fed back from the target business system before sending the authentication result to the target connection module identified by the connection module identifier.

4. The system according to claim 3, wherein the authorization information has an effective time limit, and the target authentication module is further configured to send the authentication information to the target business system and acquire authorization information with updated effective time limit fed back from the target business system in response to determining that the effective time limit is less than a threshold.

5. The system according to claim 1, wherein the target authentication module has a corresponding relationship with the target business system, and the target connection module is further configured to determine the target authentication module according to the corresponding relationship between the target authentication module and the target business system before sending the authentication request to the target authentication module.

6. The system according to claim 1, wherein the target connection module is pre-configured with a model identifier of the target authentication module, the model identifier is configured to identify the target authentication module, and the target connection module being configured to send the authentication request to the target authentication module comprises:
the target connection module being configured to send the authentication request to the target authentication module identified by the model identifier.

7. The system according to claim 1, wherein the authentication result comprises authentication passing, and the target connection module is further configured to call the target interface based on the authentication result.

8. An interface calling method applied to a target connection module included in an integrated system, wherein the target connection module is connected to a target business system, the target business system belongs to a business system set, authentication information required for the target business system included in the business system set is the same, and the method comprises:
in response to acquiring a call instruction of a target interface, sending an authentication request to a target authentication module included in the integrated system, wherein the target interface is an interface of the target business system, the authentication request comprises a connection module identifier, the connection module identifier is configured to identify the target connection module, and the target authentication module is connected to the target business system, and the target authentication module is configured to obtain an authentication result based on using the authentication information to authenticate in the target business system; and
acquiring the authentication result fed back from the target authentication module, wherein the authentication result is configured to call the target interface.

9. The method according to claim 8, wherein the target authentication module has a corresponding relationship with the target business system, and before sending the authentication request to the target authentication module, the method further comprises:
determining the target authentication module according to the corresponding relationship between the target authentication module and the target business system.

10. The method according to claim 8, wherein the target connection module is pre-configured with a model identifier of the target authentication module, the model identifier is configured to identify the target authentication module, and sending the authentication request to the target authentication module comprises:
sending the authentication request to the target authentication module identified by the model identifier.

11. The method according to claim 8, wherein the authentication result comprises authentication passing, and the method further comprises:
calling the target interface based on the authentication result.

12. An authentication method applied to a target authentication module included in an integrated system, wherein the target authentication module is connected to each target business system included in a business system set, authentication information required for the target business system included in the business system set is the same, and the method comprises:
in response to acquiring an authentication request, sending an authentication result to the target connection module identified by a connection module identifier included in the authentication request, wherein the authentication result is obtained by the target authentication module using the authentication information to authenticate in the target business system, the authentication result is configured to call a target interface, and the target connection module is connected to the target business system included in the business system set, and the target connection module is configured to call the target interface of the target business system.

13. The method according to claim 12, wherein after responding to acquiring the authentication request and before sending the authentication result to the target connection module identified by the connection module identifier, the method further comprises:
sending the authentication information to the target business system; and
acquiring the authentication result fed back from the target business system.

14. The method according to claim 12, wherein the authentication result comprises authorization information, and before sending the authentication result to the target connection module identified by the connection module identifier, the method further comprises:
sending the authentication information to the target business system and acquiring the authorization information fed back from the target business system.

15. The method according to claim 14, wherein the authorization information has an effective time limit, and the method further comprises:
in response to determining that the effective time limit is less than a threshold, sending the authentication information to the target business system and acquiring authorization information with updated effective time limit fed back from the target business system.

16. An electronic device, comprising:
one or more processors; and
a storage apparatus storing one or more programs,
wherein when the one or more programs are executed by the one or more processors, the one or more processors implement the interface calling method according to claim 8.

17. An electronic device, comprising:
one or more processors; and
a storage apparatus storing one or more programs,
wherein when the one or more programs are executed by the one or more processors, the one or more processors implement the authentication method according to claim 12.

18. A computer-readable medium, wherein a computer program is stored on the computer-readable medium, and when the program is executed by a processor, the interface calling method according to claim 8 is implemented.

19. A computer-readable medium, wherein a computer program is stored on the computer-readable medium, and when the program is executed by a processor, the authentication method according to claim 12 is implemented.
